(19) United States
(12) Patent Application Publication
(10) Pub. No.: US 2003/0230859 A1
(43) Pub. Date: Dec. 18, 2003

(54) Closed annular seal

(76) Inventors: Hirokazu Hisano, Ako-shi (JP); Aso Masayuki, Yokohama-shi (JP)

Correspondence Address: W.L. Gore & Associates, Inc., 551 Paper Mill Road, P.O. Box 9206, Newark, DE, 19714-9206, US

(21) Appl. No.: 10/410,661

(22) Filed: Apr. 9, 2003

(30) Foreign Application Priority Data
Apr. 16, 2002 (JP) JP 02-113876

(51) Int. Cl. F16L 17/06

(52) U.S. Cl. 277/610; 277/608

(57) ABSTRACT

A closed annular seal made by joining the two lengthwise end portions of a stretched porous polytetrafluoroethylene band-shaped body, wherein the length w from the internal peripheral portion to the external peripheral portion of the seal is greater than the width t of the external peripheral surface, the annular portion of the seal may be slanted, and the angle of elevation of the annular portion in relation to a horizontal plane formed at one edge of the internal peripheral surface is 0 to 45°.

### FIELD OF THE INVENTION

The present invention relates to a closed annular seal that is particularly useful as a seal for surface contact sections in flange portions of pipes and receptacles (including tanks), manhole covers, and other such industrial equipment.

### BACKGROUND OF THE INVENTION

Polytetrafluoroethylene (PTFE) seals with superior corrosive resistance are widely used in joint sections of pipes through which corrosive fluids flow in the fields of medicine, food products, chemistry, and the like.

For example, seals are employed comprising unstretched polytetrafluoroethylene manufactured by sintering (hereinafter also referred to as “sintered PTFE”). However, because sintered PTFE is hard, conformity with minute irregularities in the piping joints (flanges and the like) is low, and sufficient sealing efficiency cannot be obtained without sufficiently raising the clamping torque. Therefore, sometimes a phenomenon occurs that is referred to as interface leakage, where fluid leaks through the interface between the joint and the seal. In particular, glass-lined joints have comparatively large irregularities and have clamping torques that are difficult to raise because of low strength. There is, therefore, an urgent need for PTFE seals that have superior adhesiveness to joints.

Stretched porous polytetrafluoroethylene (hereinafter also abbreviated as “ePTFE”) seals are receiving attention as PTFE seals that are capable of increased adhesiveness with joints and have a comparatively low clamping force. Compared to sintered PTFE, ePTFE seals are soft and can be easily deformed in the direction of seal thickness, and therefore have higher adhesiveness with joints and superior sealing properties. For example, Utility Model Application Laid-open No. H3-89133 discloses an ePTFE seal in which an ePTFE film laminate obtained by laminating and integrating ePTFE films to a specific thickness has been stamped into a ring shape or the like. FIG. 19 is a schematic perspective view for describing the method for manufacturing a seal by such stamping. With the stamping method, the seal is manufactured by stamping ring shapes 20 from a sheet-shaped laminate 10 obtained by laminating a plurality of ePTFE films. However, the stamped laminate 10 is uneconomical because it has no other uses and is discarded regardless of whether much unused ePTFE remains.

FIG. 20 is a schematic perspective view for describing another method for manufacturing an ePTFE annular seal. In this example, the annular seal is manufactured by winding and laminating an ePTFE film onto a mandrel 50 to produce a laminated cylinder 11, and then cutting the laminated cylinder at intervals that are equivalent to the thickness p of the seal. However, such a manufacturing method is uneconomical either because of the need to prepare in advance mandrels having various diameters in accordance with the inside diameter and other properties of the joint.

Band-shaped seals (rod-shaped seals, tape-shaped seals, and the like) are also known in addition to annular seals. These seals are manufactured by extrusion-molding PTFE into a rod shape or tape shape and then stretching it uniaxially in the longitudinal direction. These seals are also manufactured by laminating and baking (affixing) a biaxially stretched PTFE film and cutting it into a band shape. Belt-shaped seals are cut to a length suitable to the size of the joint (flange or the like), are employed in a ring shape formed by being attached along the seal surface of the flange to ultimately superimpose both end portions in the longitudinal direction, and are economical because they can be used effectively in joints of any shape. A tape-shaped seal is disclosed, for example, in Great Britain Patent No. 5,964,465 as such a band-shaped seal. FIG. 21 is a schematic perspective view of this tape-shaped seal 30. In the seal 30, laminated sheet obtained by laminating biaxially stretched ePTFE films is slit at a specific width q, an adhesive layer (not shown) is further laminated on one laminated surface, and the top surface of the adhesive layer is protected by release paper (not shown).

However, band-shaped seals require a high level of skill of the operator because not only must the circular closing operation at the mounting location be forced, but it is necessary to prevent leakage through the superimposed portion whenever both end portions are superimposed.

The present invention is made with attention to circumstances such as those described above, and an object thereof is to provide a seal in which the operating load at the mounting location can be reduced even with a sealing arrangement that uses a band-shaped seal.

### SUMMARY OF THE INVENTION

The closed annular seal of the present invention, which is capable of attaining the above-mentioned objects, is a closed annular seal formed by joining either one or a plurality of stretched porous polytetrafluoroethylene band-shaped bodies at the two lengthwise ends thereof, wherein the main point is that the length w from the internal peripheral portion to the external peripheral portion of the seal (in other words, the width w of the annular flat surface orthogonal to the external peripheral surface) is greater than the width t of the external peripheral surface, the annular portion of the seal may be slanted, and the angle of elevation (angle of elevation in relation to a horizontal plane formed at one edge of the internal peripheral surface) is 0 to 45°.

The annular portion preferably has a laminated structure of stretched porous polytetrafluoroethylene layers. Particularly, the stretched porous polytetrafluoroethylene layers are preferably laminated in either the length w direction or the width t direction of the external peripheral surface. When laminated in the length w direction, not only stretched porous polytetrafluoroethylene layers, but also nonporous polytetrafluoroethylene layers should preferably be laminated.

The closed annular seal may have an adhesive layer formed on either of its circular, flat surfaces. It is preferable that at least one end portion in the lengthwise direction of the band-shaped body is taper cut and that the taper cut surface forms at least part of the joint of the band-shaped body. When joining the two end portions of the band-shaped body, means such as shown below in (1) to (3) may be utilized:

(1) double-sided self-adhesive tape

(2) adhesive

(3) heat fusion or ultrasonic welding through the agency of at least one component selected from a tetrafluoroethylene-hexafluoro propylene copolymer film and a tetrafluoroethylene-perfluoroalkyl vinyl ether copolymer film.

The circular seal of the present invention is obtained by bending either one or a plurality of band-shaped bodies into a circle or by bending a plurality of band-shaped bodies into a circle so that they join in the lengthwise direction, and then temporarily fixing and heat setting the bodies to maintain this circular configuration. The two end portions of the band-shaped body can be joined either before, after, or simultaneously with the heat setting.

The seal of the present invention can be handled in the same manner as stamped seals or other such common seals because a roughly tabular shape is maintained regardless of whether a band-shaped body is used. The seal can therefore be installed with greater ease on flanges and other such sealed locations.

### BRIEF DESCRIPTION OF THE DRAWINGS

The present invention is illustrated by way of example and not limitation in the accompanying figures.

FIG. 1 is a schematic perspective view showing one example of a closed annular seal of the present invention.

FIG. 2 is a schematic perspective view of a band-shaped body employed in the closed annular seal in FIG. 1.

FIG. 3 is a schematic perspective view showing the closed annular seal in FIG. 1 in a deformed state.

FIG. 4 is a schematic perspective view showing the mounting conditions of the closed annular seal in FIG. 1.

FIG. 5 is a schematic cross-sectional view of a flange onto which the closed annular seal in FIG. 1 has been installed.

FIG. 6 is a fragmentary expanded side view of another example of the closed annular seal of the present invention.

FIG. 7 is a schematic perspective view showing yet another example of the closed annular seal of the present invention.

FIG. 8 is a cross-sectional view along the line A-A′ in FIG. 7.

FIG. 9 is a schematic perspective view showing another example of the closed annular seal of the present invention.

FIG. 10 is a schematic cross-sectional view of a flange onto which the closed annular seal in FIG. 9 has been installed.

FIG. 11 is a schematic plan view showing yet another example of the closed annular seal of the present invention.

FIG. 12 is a schematic perspective view showing another example of the closed annular seal of the present invention.

FIG. 13 is a schematic perspective view showing yet another example of the closed annular seal of the present invention.

FIG. 14 is a schematic perspective view showing an example of the method for manufacturing the ePTFE band-shaped body employed in the present invention.

FIG. 15 is a schematic perspective view showing another example of the method for manufacturing the ePTFE band-shaped body employed in the present invention.

FIG. 16 is a schematic perspective view showing yet another example of the method for manufacturing the ePTFE band-shaped body employed in the present invention.

FIG. 17 is a schematic perspective view showing an example of the method for manufacturing the closed annular seal of the present invention.

FIG. 18 is a schematic plan view showing an example of the method for manufacturing the closed annular seal of the present invention.

FIG. 19 is a schematic perspective view showing an example of a conventional closed annular seal.

FIG. 20 is a schematic perspective view showing another example of a conventional closed annular seal.

FIG. 21 is a schematic perspective view showing an example of a conventional band-shaped seal.

### DETAILED DESCRIPTION OF THE INVENTION

The present invention is described in further detail below with reference to the accompanying diagrams as necessary.

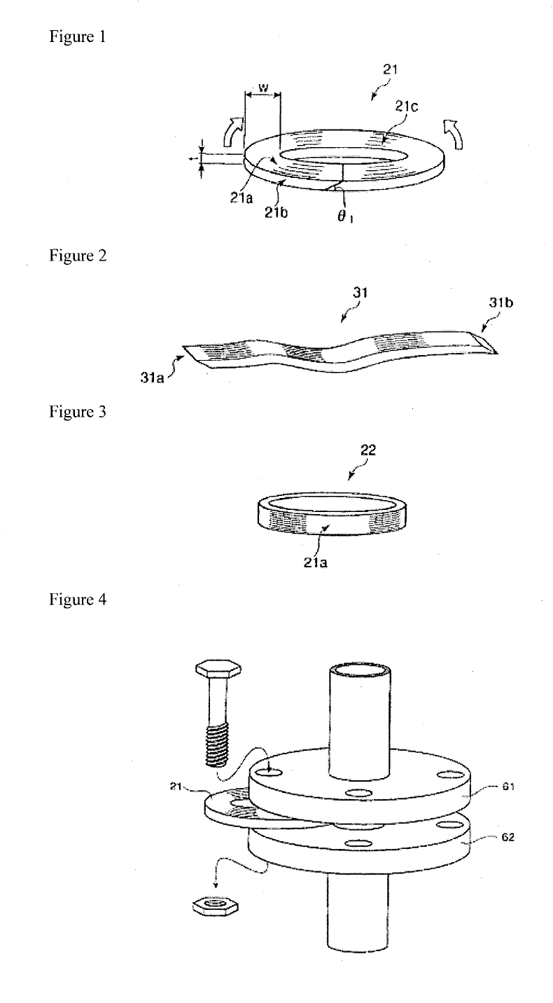

FIG. 1 is a schematic perspective view showing one example of a closed annular seal 21 of the present invention, where the closed annular seal is obtained by joining two lengthwise end portions 31a and 31b of a stretched porous polytetrafluoroethylene (ePTFE) band-shaped body 31 shown in FIG. 2.

The closed annular seal 21 of the present invention has a substantially tabular shape, where the width w of the annular flat surface 21a (the length w from the internal peripheral portion to the external peripheral portion of the seal) is greater than the width t (hereinafter also referred to as “seal thickness”) of the external peripheral surface 21b. Such a substantially tabular sealing configuration with a closed circular band-shaped seal is generally easily deformed in the direction of contraction (the direction indicated by the arrow in FIG. 1) because the external peripheral portion is pulled farther out than the internal peripheral portion. In other words, as shown in FIG. 3, the seal can be easily deformed into a substantially vertical cylinder 22 with a large width t of the external peripheral surface and an upright annular flat surface 21a. However, the closed annular seal 21 of the present invention can be appropriately molded and the shape thereof can be set to an extent wherein the substantial tabular shape can be maintained without deforming the substantially vertical cylinder. In other words, unlike the situation described above wherein a band-shaped seal is attached to a flange and made into a circle, the circular seal of the present invention is characterized in that the substantially tabular shape can be maintained without anything to support it. Therefore, the ability to maintain the substantially tabular shape is believed to be derived from the characteristics of the ePTFE constituting the band-shaped body. The below-described porous structure composed of ePTFE nodes and fibrils is provided with enough elasticity and strength to absorb the stress of elongations in the external peripheral portion and the stress of compression in the internal peripheral portion occurring when the band-shaped body is made into a circle. In the seal 21, the layer 21c formed on the ePTFE film is laminated in the direction of the width w of the annular flat surface 21a.

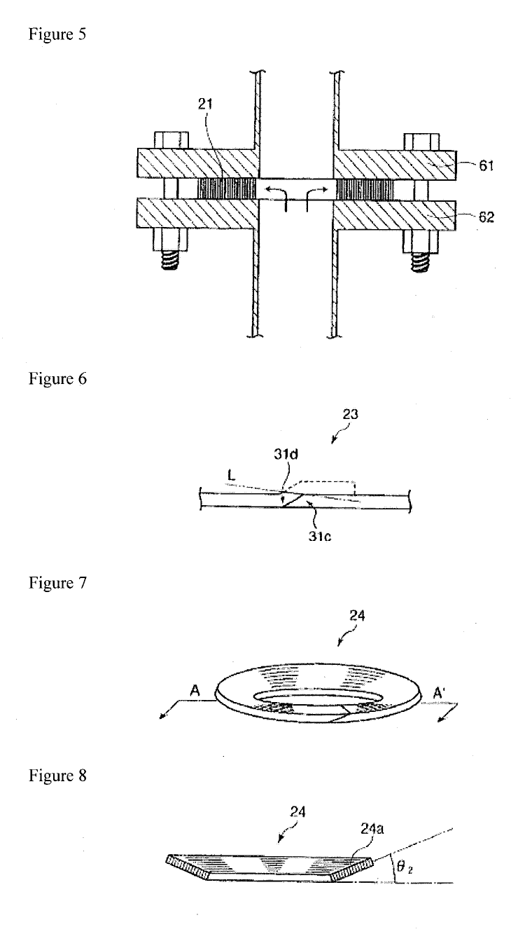

Such a seal can be handled in the same manner as a general seal of the stamped type or the like in order to maintain the substantially tabular shape regardless of whether the band-shaped body is used. Therefore, the work for mounting a flange or the like on the location to be sealed can be reduced. FIG. 4 is a schematic perspective view for describing the process of mounting the seal 21 in a flange, and FIG. 5 is a schematic cross-sectional view showing a flange on which the seal 21 has been installed. As shown in FIG. 4, when employing the closed annular seal 21, slightly separating the flanges 61 and 62 by removal of clamping tools (in this example, bolts and nuts) or the like makes it possible to insert the seal 21 into a small gap between the flanges 61 and 62, whereby the work can be simplified compared to a band-shaped seal wherein the flanges 61 and 62 must be separated by a considerable distance to maintain work space.

Unlike the band-shaped seal, the closed annular seal does not require a high level of skill of the operator because there is no danger of leakage from failure of the closed circle (failure of the joint). Furthermore, although generally a closed annular seal using ePTFE is soft and must therefore be supported by a metallic ring or the like to have a large diameter, it is possible to maintain a specific shape with the closed annular seal of the present invention, and a metallic ring or the like is therefore not always needed. In this example, the annular flat surface 21a serves as the seal surface. When the closed annular seal 21 is applied to a flange, as shown in FIG. 5, the ePTFE is laminated so as to be orthogonal to the direction of fluid leakage (the direction shown by the arrows in FIG. 5).

Since the width w of the annular flat surface is greater than the thickness t of the seal, the present invention, which enables the substantially tabular shape to be maintained, has greater significance because it is generally difficult to maintain a substantially tabular shape. The ratio (w/t) of the width w to the thickness t is, for example, greater than 1.0, preferably 2 or greater, and more preferably 3 or greater. The ratio (w/t) is usually 50 or less (for example, 10 or less).

The width w can be selected from a range of, for example, 5 mm or greater (preferably 10 mm or greater) and 100 mm or less (preferably 75 mm or less). The thickness t can be selected from a range of, for example, 0.5 mm or greater (preferably 1.0 mm or greater). The inside diameter of the closed annular seal can be selected from a range of, for example, 100 mm or greater (preferably 200 mm or greater) and 3000 mm or less (preferably 2000 mm or less). The significance of the present invention, which enables the substantially tabular shape to be maintained, increases with increased width w, reduced thickness t, and reduced inside diameter because it generally becomes difficult to maintain a substantially tabular shape under these conditions.

In the seal 21 in FIG. 1, the two end portions 31a and 31b of the employed band-shaped body 31 (see FIG. 2) are taper cut, and the taper cut surfaces are joined so as to overlap. Taper cutting makes it possible to more certainly prevent leakage from the joint. The area of the joint surface can also be enlarged and the reliability of the joint can be increased. The taper cut surfaces should form at least part of the joint of the band-shaped body. For example, the taper cut surfaces do not necessarily need to be overlapped exactly, but may be overlapped off center. The taper angle θ is not particularly limited and may, for example, be about 5 to 45°. Even though tapers are formed on both lengthwise end portions 31a and 31b of the band-shaped body 31 in the example in FIG. 1 (see FIG. 3), a taper may be formed on only one end portion. FIG. 6 is a fragmentary expanded side view of a closed annular seal 23 on which a taper is formed on only one end portion. As shown in FIG. 6, even though a taper is formed on only one end portion 31c, both end portions 31c and 31d can be joined by placing the other end portion 31d over the taper cut surface. The end portion 31d on the side with no taper cut is cut along the line L to remove the ridge after this end portion is placed over the other end portion 31c. The cut line for removing the ridge is not particularly limited as long as it is sufficient to prevent leakage resulting from the ridge, and the cut line and annular flat surface may be in the same plane, for example. The joint surface area can also be enlarged by methods other than taper cutting.

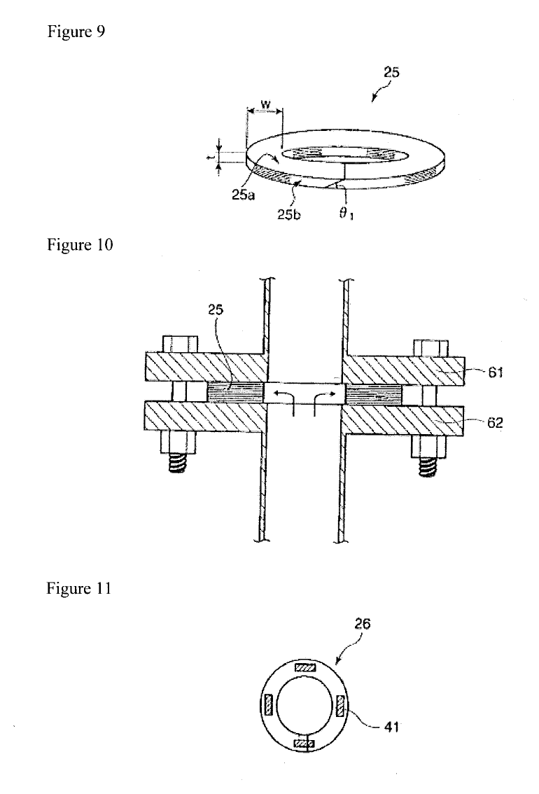

Although the annular portion 21a is perfectly level in the seal 21 in FIG. 1, the annular portion 21a may also be slanted. FIG. 7 is a schematic perspective view showing such a seal 24, and FIG. 8 is a cross-sectional view along the line A-A′ of the seal 24 in FIG. 7. This seal can be employed in a manner similar to that of a stamped seal or other such common seal even if the angle of elevation θ₂ of the annular portion 24a (inclination in relation to the horizontal) is not 0° (that is, even if the annular portion is slanted). The seal is harder to use if the angle of elevation θ₂ is too great, therefore θ₂ should be 45° or less, preferably 20° or less, and more preferably 10° or less (particularly 0°).

The closed annular seal of the present invention is not particularly limited as long as it is made of stretched porous polytetrafluoroethylene (ePTFE), and may, for example, be made of either uniaxially stretched PTFE or biaxially stretched PTFE. The uniaxially stretched PTFE is characterized in that on the micro level, there are thin, island shaped nodes (folding crystals) substantially orthogonal to the stretching direction, and lattice shaped fibrils (linear clusters of molecules by which the folding crystals are uncoiled and extracted by stretching) for linking the nodes are oriented in the stretching direction. The biaxially stretched PTFE is characterized in that on the micro level, the fibrils expand in all directions and the nodes linking the fibrils are interspersed in an island shape, forming a cobweb-shaped fibrous configuration with a large number of spaces defined by the fibrils and nodes.

The average pore diameter of the ePTFE can be appropriately set in accordance with the draw ratio, for example, to from about 0.05 to 5.0 μm, or preferably about 0.5 to 1.0 μm. As will be described later, in the present invention seals can be formed by laminating ePTFE films, and if the average pore diameter is too great, the area of films in contact with each other is small, and adhesiveness between the films is low. Also, if the average pore diameter is too great, the fluid passing through the internal portion of the seal easily leaks (penetration leakage), and seal properties are reduced. Conversely, reducing the average pore diameter any further creates restrictions in terms of manufacturing.

The porosity of the ePTFE can be appropriately set in accordance with the draw ratio, and can be selected from a range, for example, of about 10 to 95%, or preferably about 30 to 85%. The porosity is preferably selected corresponding to the service conditions of the seal (surface roughness of the clamping member, clamping force, or the like). Softness increases as porosity is increased, and seal properties can be obtained at a small clamping force even in relation to a rough surface. In addition, the likelihood of penetration leakage decreases with reduced porosity.

The closed annular seal of the present invention may have a laminated structure obtained by laminating ePTFE films, or a nonlaminated structure obtained using a comparatively thick ePTFE film (tape) alone. Employing a laminated band-shaped body obtained by laminating uniaxially or biaxially stretched ePTFE films makes it possible to form a laminated structure. The preferred closed annular seal is a laminated structure type (particularly a laminated structure type obtained using biaxially stretched ePTFE).

The thickness of the ePTFE films is not particularly limited and may, for example, be 5 μm or greater (particularly 15 μm or greater) and 500 μm or less (particularly 150 μm or less).

The ePTFE films may be laminated in the widthwise w direction of the annular flat surface 21a as shown in FIG. 1, but also may be laminated in the widthwise t direction of the external peripheral surface. FIG. 9 is a schematic perspective view of such a seal 25, and FIG. 10 is a schematic cross-sectional view showing the mounting state of the seal 25. As shown in FIGS. 9 and 10, the ePTFE layers run parallel with the direction of fluid leakage (the direction indicated by the arrow in FIG. 10) when the seal 25 is used on which ePTFE films are laminated in the widthwise t direction of the external peripheral surface 25b (the direction of the seal thickness). Even in such a situation, setting the clamping load to a high level makes it possible to collapse the pores and to prevent penetration leakage. When laminating in the widthwise direction of the external peripheral surface, it is preferable to employ a biaxially stretched PTFE seal. Employing a biaxially stretched PTFE makes it possible to increase the strength in the widthwise w direction of the annular flat surface 25a and to suppress creep (cold flow) deformation resulting from clamping pressure.

Although with an ePTFE seal it is possible, due to superior elasticity, to successfully prevent leakage (interface leakage) from between a flange or other such sealed member and the ePTFE seal, instances of penetration leakage do occur as described above because the ePTFE seal has a porous structure. Therefore, it is preferable to assure that penetration leakage can be prevented by using the seal of the present invention in combination with a film that has a nonporous structure. For example, penetration leakage can be securely prevented by covering the surfaces (for example, the internal peripheral surface and the annular flat surface) with sintered PTFE, with the closed annular seal of the present invention as the core. In a seal 21 wherein the ePTFE films are laminated in the widthwise w direction of the annular flat surface 21a as shown in FIG. 1, it is possible to securely prevent penetration leakage because a nonporous film can be made orthogonal to the direction of fluid leakage, as shown in FIG. 5, when the nonporous film is inserted in place of one of the ePTFE films. A seal using a combination of films with such nonporous structures is particularly effective in seals for fluids such as organic solvents or gases, for which leakage is more difficult to prevent than for aqueous solvents.

In addition to metallic films (metallic foil), various other synthetic resin films can be employed as the nonporous film, but it is preferable to employ a fluorine resin film (polytetrafluoroethylene (PTFE) film, tetrafluoroethylene-hexafluoro propylene copolymer (FEP) film, tetrafluoroethylene-perfluoroalkyl vinyl ether copolymer (PFA) film, or the like), and particularly preferable would be a PTFE film (for example, a sintered PTFE film, an unstretched PTFE film, a film densified by compressing or otherwise processing ePTFE (dense PTFE film) or the like).

The closed annular seal of the present invention may have an adhesive layer formed on one of its annular flat surfaces (for example, in the case of the seal in FIG. 1, the annular flat surface 21a or the annular flat surface on the reverse side thereof). In particular, forming an adhesive layer when the annular flat surface (annular portion) is slanted makes it possible to further enhance ease of operation because the surface can easily be flattened when it is mounted on a sealed member.

The adhesive layer may be formed entirely or partially over one annular flat surface. When forming the layer partially, it is preferable to form a plurality of adhesive portions at approximately equal intervals. For example, four adhesive portions 41 may be formed at equal intervals in the seal 26 shown in FIG. 11.

The type of adhesive layer is not particularly limited as long as it is capable of adhering to the seal of the present invention, and, for example, an acrylic adhesive, rubber adhesive, or the like can be employed. An acrylic adhesive is preferred in terms of heat resistance or the like.

The thickness of the adhesive layer is not particularly limited and may, for example, be about 3 to 200 μm, or preferably about 5 to 25 μm.

The surface of the adhesive layer is usually protected by release paper. Various types of publicly known release paper can be used as the release paper. It is preferable, for example, to use a paper or resin film (polyester film, polyimide film, or the like) coated or impregnated with a silicone resin, a fluororesin, or other such release agent; or a polyethylene film, polypropylene film, or other such resin film with superior release properties.

The shape of the circle is not particularly limited as long as the seal of the present invention is a closed circle, and may be appropriately selected according to the shape of the sealed member (flange or the like). The shape may, for example, be selected from toroidal shapes, elliptic annular shapes, and polygonal annular shapes (rectangular annular shapes or the like).

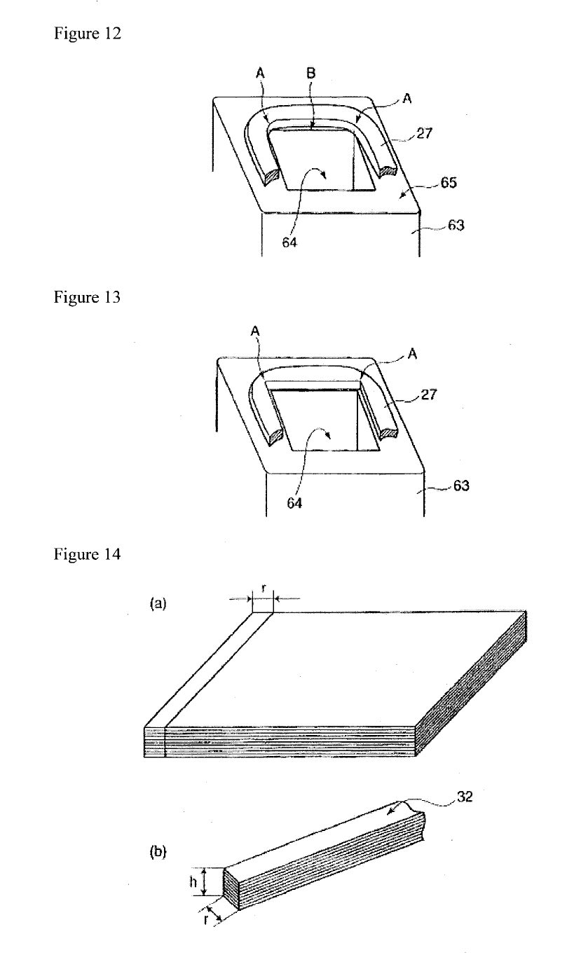

When a polygonal annular shape (a rectangular annular shape or the like) is used, the inner sided of the corner portions are preferably cut off and removed as necessary. FIG. 12 is a fragmentary cutaway schematic perspective view of a polygonal annular seal 27 before the inner sides of the corner portions are cut away and removed, and shows a rectangular annular shape in this example. In this example, a rectangular annular seal 27 is disposed on a rectangular flange 63. As is made clearer than in FIG. 11, the corner portions A of the polygonal seal do not generally have perfect corners, but have slight bulges. Therefore, due to the relationship of the flange 63 with the channel 64, the corner portions A do not come into direct contact with the clamping surface 65 of the flange 63 but protrude from the channel 64, disrupting the flow of fluid. When the seal 26 is applied to a flange whose channel is even smaller than the flange 63, the fluid leakage and the like can be prevented, but the fluid-accumulating portion B sometimes becomes too large. By contrast, as shown in FIG. 13, when the inner sides of the corner portions A are cut away and removed so as to form perfect corners, the shape of the channel 64 in the flange 63 and the internal shape of the seal can be approximated, making it possible to reduce turbulent flow, fluid accumulation, or the like.

All of the seals in the examples shown in the above-described diagrams have a single band-shaped body joined at one location, but they may also have a plurality of band-shaped bodies (for example, two) joined at a plurality of locations (for example, two).

The closed annular seal of the present invention is manufactured from an ePTFE band-shaped body. The ePTFE can be obtained by molding a fine powder of PTFE while mixing it with a molding aid, then stretching the resulting mixture at a high temperature and a high speed after removing the molding aid, and baking as necessary. The details thereof are described in Japanese Patent Publication No. S51-18991, for example.

As described above, an ePTFE film laminate may be employed as the ePTFE band-shaped body. The method for manufacturing such a band-shaped laminate is not particularly limited, and manufacturing can be done according to FIGS. 14 to 16, for example. That is, in the example in FIG. 14, a band-shaped laminate 32 is obtained by laminating a specific number of ePTFE films, forming a tabular laminate with a laminate height h, and slitting the tabular laminate at a specific width r.

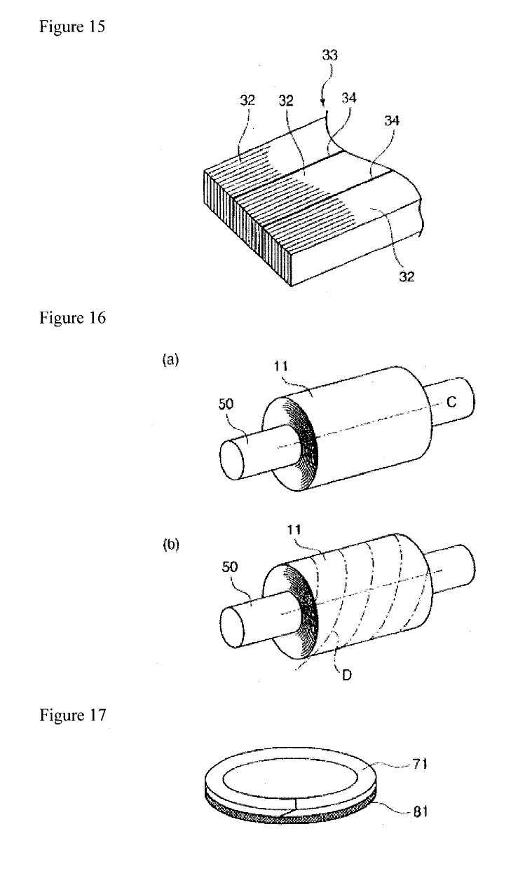

In the example in FIG. 15, a band-shaped laminate 33 is obtained by layering a plurality (three in this example) of band-shaped laminate units 32 obtained in a manner similar to that of FIG. 14, and joining them via a joining layer 34 (a layer similar to a joining layer, to be described below, that is employed in joining and circularizing the two end portions of the band-shaped body). The direction for layering the laminate units 32 is not particularly limited, and may be the same direction as the lamination direction of the ePTFE films similar to the example in FIG. 15, or the direction orthogonal to the lamination direction of the ePTFE films. In addition, the joining layer 34 is not absolutely necessary, and the units may be joined directly by heat fusion.

In the example in FIG. 16(a), an ePTFE film laminated cylinder 11 is manufactured by winding and laminating ePTFE films onto a mandrel 50, a tabular laminate is manufactured by cutting the laminated cylinder 11 open along the axial direction of the mandrel 50 (see the dotted line C in FIG. 16(a)), and a band-shaped laminate is obtained by slitting the tabular laminate at a specific width similar to the example in FIG. 14. In the example in FIG. 16(b), a band-shaped laminate is manufactured by slitting the peripheral surface of the laminated cylinder 11 in a spiral shape (see the dotted line D in FIG. 16(b)).

When manufacturing an ePTFE band-shaped laminate from ePTFE films, it is preferable to have the films adhere by baking at a suitable step, particularly before slitting. The baking temperature is preferably set at the melting point of polytetrafluoroethylene or greater, specifically 327° C., and particularly 350° C. or greater. Because the PTFE resin undergoes thermal degradation and holes open when the baking temperature is too high, the baking temperature is preferably 400° C. or less, and particularly 380° C. or less.

To fashion an ePTFE band-shaped body into a closed annular seal, the ePTFE band-shaped body must be bent into a circle and then temporarily fixed and heat set to maintain the circular shape. When the ePTFE band-shaped body is circularized, it may be fashioned into a tabular shape (see FIG. 1) or a vertical cylindrical shape (see FIG. 3). When the body is circularized into a vertical cylindrical shape, it can be made into a flat plate by laying the side wall of the closed circular body down in the external direction and expanding it into the shape of a flange, and temporarily fixing and heat setting the resulting state makes it possible to manufacture the closed annular seal of the present invention. In either case, it is important to heat set the material in a state in which it is circularized into a substantially tabular shape. The details of the reasons that the substantially tabular shape can be maintained are unclear, but it is surmised that it is because the residual stress resulting from circularization (forming a substantially flat plate) can be removed by heat setting.

When circularizing before heat setting, there is a low correlation between the ease of circularization and the lamination direction of the ePTFE films. That is, the ease of circularization is about the same irrespective of the lamination direction of the ePTFE films.

During circularization, the body may be perfectly circularized by joining the two end portions of the band-shaped body before heat setting, although it may also be perfectly circularized by apparently circularizing (temporarily circularizing) the two end portions of the band-shaped body without joining them before heat setting, and then joining the two end portions after heat setting. Furthermore, the body may also be perfectly circularized by joining the two end portions during heat setting by means to be described below.

Various means can be employed to join the two end portions, including heat fusion between the two end portions. For example, it is simple to join the two end portions using (via) a joining layer. Double-sided self-adhesive tape, adhesives, and plastic film are possible examples of such a joining layer. Examples of preferred plastic films include tetrafluoroethylene-hexafluoropropylene copolymer films (FEP films), tetrafluoroethylene-perfluoroalkyl vinyl ether copolymer films (PFA films), and other such fluororesin films. Fluororesin films have superior heat resistance and chemical resistance.

When a plastic film is used, for example, the two end portions can be brought into contact via the plastic film and can be joined by heat fusion or ultrasonic welding. Consequently, if a plastic film with a melting point lower than the heat setting temperature is used, it is also possible to join the two end portions during heat setting.

The band-shaped body circularized as described above must be temporarily fixed prior to heat setting. When the body is not perfectly circularized but is only apparently circularized (temporarily circularized), it is because it does not settle into shape unless temporarily fixed, and when the body is perfectly circularized, it is because the external peripheral surface is subject to stress in the direction of contraction, and is easily deformed into a vertical cylindrical shape (see FIG. 3).

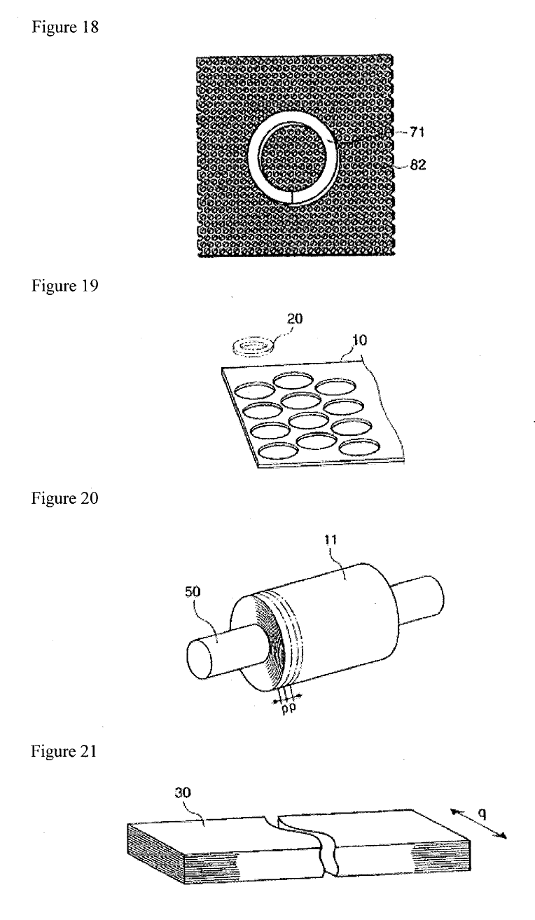

For temporarily fixing, it is preferable to fix the circularized band-shaped body onto a support. The support may be a metallic plate or another such rigid plate; a rigid plate (punching metal or another such punching plate or the like) provided with a plurality of small holes, or another such plate-shaped support, or a ring-shaped metallic plate or another such ring-shaped support. FIGS. 17 and 18 are schematic diagrams that depict the temporary fixing in further detail. In the example in FIG. 17, a circularized band-shaped body 71 is temporarily fixed onto a ring-shaped metallic plate 81 of roughly the same shape, and in the example in FIG. 18, the band-shaped body is temporarily fixed onto punching metal 82. Using punching metal or another such punching plate is convenient because of the ability to arbitrarily set the circular planar shape (cylinder, ellipsoid, rectangle, or the like) can be set as seen fit.

The method for fixing onto the support is not particularly limited, and possible examples include adhesion means (adhesives, adhesive tape, or the like), binding means (cords, tape, or the like), interposition means (clips or the like), and misalignment prevention means (pins or the like). When using adhesion means, it is preferable that the adhesiveness thereof be sufficient to allow the circularized body and the support plate to be separated after heat setting.

The temperature of heat setting may, for example, be 50° C. or greater (preferably 80° C. or greater). A higher temperature makes it more possible to maintain the shape. However, it is preferable to set the heat setting temperature at 400° C. or less (preferably 200° C. or less).

The heating means employed during heat setting is not particularly limited and may include radiation heating in a furnace, conductive heating with a heating plate (particularly contact heating under pressure from a heating plate), convection heating with a heating fluid (gas, vapor, or the like), or the like.

After heat setting is complete, the temperature is lowered to about room temperature and the support is removed. After heat setting, the circularized band-shaped body acquires the necessary configuration and the shape is set. The closed annular seal of the present invention can be obtained by completing heat setting when the two end portions of the band-shaped body are joined together before or during heat setting. In addition, the closed annular seal of the present invention can be obtained by joining the two end portions together after heat setting if they have not been joined. Depending on the state of separation of the two end portions, the annular portion is sometimes slanted following the formation of a closed circuit when the end portions are joined together (fashioned into a closed circuit) after heat setting, and such occurrences are also included in the present invention.

In the closed annular seal of the present invention obtained as described above, the circular flat portion is preferably employed as the seal surface, but the external peripheral surface may also be employed as the seal surface. The closed annular seal of the present invention can be used as a fluid seal in various locations as necessary, for example, in joints (flange portions and the like) of pipes and receptacles (including tanks), manhole covers, and the like. It also may be employed as a seal for a surface contact section of industrial equipment and the like.

### EXAMPLES

Practical examples are given below to describe the present invention in greater detail, but the present invention is not restricted by the practical examples described below, and can of course be implemented with added modifications within a range adaptable to the purpose described above and below.

The practical examples below employ a biaxially stretched PTFE band-shaped body obtained as described below.

Biaxially Stretched PTFE Band-Shaped Body 1

A band-shaped body (tape) having the dimensions of width 25 mm×length 3,000 mm×thickness 4 mm and where the lamination direction of ePTFE film was the direction of the thickness, was obtained by slitting a 4 mm sheet (sold by Japan Gore-Tex, Inc.,) of “GORE-TEX Hyper Sheet” onto which a biaxially stretched PTFE film had been laminated in the direction of thickness.

Biaxially Stretched PTFE Band-Shaped Body 2

An ePTFE film having a thickness of 60 μm and a porosity of 80% was created by mixing 22 parts by weight of solvent naphtha with 100 parts by weight of a powder (fine powder) of polytetrafluoroethylene obtained by emulsion polymerization, forming the resulting paste resin into a film shape, heating the molded paste film above the boiling point of solvent naphtha to remove the solvent naphtha by evaporation, and then biaxially stretching the product at a temperature below the melting point of polytetrafluoroethylene and a speed of 10% per second or greater.

The ePTFE film was wound and laminated onto a stainless hollow mandrel with a diameter of 1,000 mm and a length of 1,500 mm. After the film was wound 110 times, the trailing end of the film was cut with a cutter and the film was fixed in place into a film laminate cylinder with double-sided self-adhesive tape so that the cut edge of the ePTFE film would not roll up.

A dense ePTFE film (nonporous film) with a thickness of 50 μm was created by layering three ePTFE films and collapsing the pores therein with a roll at a set pressure (2.4 kN/cm) and temperature (70° C.). The nonporous film was wound once onto the film laminate cylinder previously created, and the cut edge was fixed in place with double-sided self-adhesive tape.

The ePTFE was then once again wound 110 times and the cut edge was fixed with double-sided self-adhesive tape.

The ePTFE film laminate cylinder with an interposed nonporous film thus fabricated was placed into an oven and baked for 60 minutes at 365° C. After baking, the laminate cylinder was removed from the oven and allowed to cool to room temperature. The shape of the laminate cylinder was about 1,000 mm (D₁)×1,020 mm (D₂)×1,500 mm (L₁), where D₁ is the inside diameter, D₂ the outside diameter, and L₁ the length in the axial direction.

After cooling, a substantially tabular laminate measuring about 1,500 mm (L₁)×3,000 mm (L₂)×10 mm (L₃) was obtained by cutting out the sections fixed in place with the double-sided self-adhesive tape. The laminate was slit in the L₂ direction at 50-mm intervals in the L₁ direction to obtain slitted bodies of about 50 mm (L₁)×3,000 mm (L₂)×10 mm (L₃). Three of these slitted bodies were pasted together in the direction of lamination (L₃) of the ePTFE film and were thermocompression bonded to obtain a rectangular column of about 50 mm (L₁)×3,000 mm (L₂)×25 mm (L₃). The length L₃ was 25 mm rather than 30 mm (=10 mm×3) because of the pressure from compression bonding. The rectangular column was again slit in the L₂ direction at 4-mm intervals in the L₁ direction to obtain a band-shaped body 2 measuring 4 mm (L₁) in thickness t, 3,000 mm (L₂) in length, and 25 mm (L₃) in width w (lamination direction of ePTFE film=width w direction). The band-shaped body 2 was mostly free of curling.

Biaxially Stretched PTFE Band-Shaped Body 3

A band-shaped body (tape) measuring 20 mm in width, 3,000 mm in length and 6 mm in thickness was obtained in the same manner as the biaxially stretched PTFE band-shaped body 2 except that changes were made to the number of windings, slit width, and other conditions.

### Example 1

The biaxially stretched PTFE band-shaped body 1 (width 25 mm×length 3,000 mm×thickness 4 mm; lamination direction of ePTFE film=thickness direction) was circularized by being temporarily fixed in place along the internal periphery and external periphery of a metallic ring (inside diameter 270 mm×outside diameter×320 mm thickness 1 mm). Since the band-shaped body 1 was too long, it was layered to about 50 mm during circularization and the excess section was cut away. When the body was temporarily fixed into a circle, it was set such that the lamination direction of the biaxially stretched PTFE was equivalent to the widthwise direction of the external peripheral surface of the band-shaped body, and was fastened onto a metallic ring using uniaxially stretched PTFE tape (width 10 mm×thickness 0.1 mm). After heating in a 100° C. oven for one hour, the body was allowed to cool naturally to room temperature. The uniaxially stretched PTFE tape was unfastened and the biaxially stretched PTFE temporary annular body was separated from the metallic ring. The inside diameter of the temporary annular body was about 290 to 295 mm, somewhat expanded since the time of temporary fixing. The width was maintained at 25 mm.

The temporary annular body was collected to an inside diameter of 270 mm, and the excess section was then cut such that the overlapping of the two ends was 20 to 30 mm. As shown in FIG. 1, only the overlapping length portion was cut at an incline (taper angle θ₁=10°). The tapered surface was coated with an adhesive (FRONT #107 made by Forefront, Inc.), and the two end portions were joined to manufacture a closed annular seal (inside diameter 270 mm). The angle of elevation of the annular portion was about 10°.

### Example 2

A temporary annular body was manufactured in the same manner as in Experimental Example 1, except that the heating conditions were 200° C. and one hour. The inside diameter of the temporary annular body was 270 mm and the measurements at the time of temporary fixing were maintained. The width was reduced from 25 mm to about 23 mm as a result of heat contraction.

A closed annular seal (inside diameter 270 mm) was manufactured by joining the two end portions in the same manner as in Experimental Example 1. The angle of elevation of the annular portion was about 0°.

### Example 3

A temporary annular body was manufactured in the same manner as in Experimental Example 1 except that the heating conditions were 300° C. and one hour. The inside diameter of the temporary annular body was 270 mm and the measurements at the time of temporary fixing were maintained. The width was reduced from 25 mm to about 21 mm as a result of heat contraction.

A closed annular seal (inside diameter 270 mm) was manufactured by joining the two end portions in the same manner as in Experimental Example 1. The angle of elevation of the annular portion was about 0°.

### Example 4

Except that the biaxially stretched PTFE band-shaped body 2 (width 25 mm×length 1,000 mm×thickness 4 mm; lamination direction of ePTFE film=widthwise direction) was used, a temporary annular body was manufactured in the same manner as in Experimental Example 1 and the two end portions were joined in the same manner as in Experimental Example 1 to obtain a closed annular seal (inside diameter 270 mm) onto which an ePTFE film had been laminated in the widthwise w direction of the annular flat surface. The external shapes of the temporary annular body and the closed annular seal were the same as in Experimental Example 1.

### Example 5

Except that the biaxially stretched PTFE band-shaped body 2 was used, a temporary annular body was manufactured in the same manner as in Experimental Example 2 and the two end portions were joined in the same manner as in Experimental Example 2 to obtain a closed annular seal (inside diameter 270 mm) onto which an ePTFE film had been laminated in the widthwise w direction of the annular flat surface. The inside diameter of the temporary annular body was 270 mm and the measurements at the time of temporary fixing were maintained. The width also remained constant at 25 mm. The angle of elevation of the annular portion when the closed annular seal was formed was about 0°.

### Example 6

Except that the biaxially stretched PTFE band-shaped body 2 was used, a temporary annular body was manufactured in the same manner as in Experimental Example 3 and the two end portions were joined in the same manner as in Experimental Example 3 to obtain a closed annular seal (inside diameter 270 mm) onto which an ePTFE film had been laminated in the widthwise w direction of the annular flat surface. The inside diameter of the temporary annular body was about 270 mm and the measurements at the time of temporary fixing were maintained. The width was reduced from 25 mm to 24 mm as a result of heat contraction. The angle of elevation of the annular portion when the closed annular seal was formed was about 0°.

As is made clear from Experimental Examples 1 to 6, a closed annular seal can be manufactured irrespective of the lamination direction of the ePTFE sheets.

### Example 7

Punching metal (thickness 2 mm) with holes 3 mm in diameter open at 5 mm intervals was used to temporarily fix a biaxially stretched PTFE band-shaped body 3 (width 20 mm×length 3,000 mm×thickness 6 mm; lamination direction of ePTFE film=widthwise direction) into an ellipse with a major axis length (inside diameter) of 400 mm and a minor axis length (inside diameter) of 300 mm. Since the band-shaped body 3 was too long, it was layered to about 50 mm during circularization and the excess section was cut away. When the body was temporarily fixed into a circle, it was set such that the lamination direction of the biaxially stretched PTFE was equivalent to the widthwise direction of the annular flat surface of the annular body, and was fastened onto punching metal using uniaxially stretched PTFE tape (width 10 mm×thickness 0.1 mm). After heating in a 150° C. oven for one hour, the body was allowed to cool naturally to room temperature. The uniaxially stretched PTFE tape was unfastened and the biaxially stretched PTFE temporary annular body was separated from the punching metal. The temporary annular body maintained an elliptical shape with a major axis length (inside diameter) of 400 mm and a minor axis length (inside diameter) of 300 mm.

A closed annular seal [major axis length (inside diameter) 400 mm, minor axis length (inside diameter) 300 mm] was manufactured by joining the two end portions in the same manner as in Practical Example 1. The angle of elevation of the annular portion was about 0°.

### Example 8

A model experiment was conducted when the biaxially stretched PTFE band-shaped body 2 was cut to a length of 300 mm and fashioned into a rectangular annular seal. That is, the same method as in Experimental Example 7 was used except that a band-shaped body with a length of 300 mm was bent into an L shape (right angle) and fixed onto punching metal. The heated L shape (corner portion) was not a perfect angle but had taken on a slight roundness, where R of the internal periphery was about 20 mm and R of the external periphery was about 50 mm.

### Example 9

Except that the body was heated for about 10 minutes by continually blowing hot air from a hot air generator (“SURE PLAJET” made by Ishikawa Electronics (Inc.); specifications: nozzle temperature=250° C.) instead of using an oven, a temporary annular body was manufactured in the same manner as in Experimental Example 4 and the two end portions were joined in the same mmanner as in Experimental Example 4 to obtain a closed annular seal (inside diameter 270 mm) onto which an ePTFE film had been laminated in the widthwise w direction of the annular flat surface.

The inside diameter of the temporary annular body was about 330 mm, expanded since the time of temporary fixing. The angle of elevation of the annular portion of the closed annular seal was about 30 to 40.

1. A closed annular seal formed by joining one or a plurality of stretched porous polytetrafluoroethylene band-shaped bodies having two lengthwise ends,
wherein the bodies are joined at the two lengthwise ends, and
wherein the close annular seal has a length (w) extending from an internal peripheral portion to an external peripheral portion of the seal and
a width (t) of an external peripheral surface
wherein the length (w) is greater than the width (t), and further, wherein the seal has an annular portion which may be slanted having an angle of elevation of the annular portion in relation to a horizontal plane formed at one edge of the internal peripheral surface of 0 to 45

2. The closed annular seal according to claim 1, wherein the annular portion has a laminated structure of stretched porous polytetrafluoroethylene layers.

3. The closed annular seal according to claim 2, wherein the stretched porous polytetrafluoroethylene layers are laminated along the length w from the internal peripheral portion to the external peripheral portion of the seal.

4. The closed annular seal according to claim 3, wherein the band-shaped bodies have stretched porous polytetrafluoroethylene layers and nonporous polytetrafluoroethylene layers.

5. The closed annular seal according to claim 2, wherein the stretched porous polytetrafluoroethylene layers are laminated along the width t of the external peripheral surface.

6. The closed annular seal according to claim 1, wherein the closed annular seal is formed in adhesive layers on either of annular flat surfaces orthogonal to the external peripheral surface.

7. The closed annular seal according to claim 1, wherein at least one lengthwise end portion of the band-shaped body is taper cut, and the taper cut surface forms at least part of the joint between the band-shaped bodies.

8. The closed annular seal according to claim 2, wherein at least one lengthwise end portion of the band-shaped body is taper cut, and the taper cut surface forms at least part of the joint between the band-shaped bodies.

9. The closed annular seal according to claim 4, wherein at least one lengthwise end portion of the band-shaped body is taper cut, and the taper cut surface forms at least part of the joint between the band-shaped bodies.

10. The closed annular seal according to claim 1, wherein both end portions of the band-shaped bodies are joined by at least one mean selected from double-sided self-adhesive tape, adhesive, heat fusion, and ultrasonic welding.

11. The closed annular seal according to claim 2, wherein both end portions of the band-shaped bodies are joined by at least one mean selected from double-sided self-adhesive tape, adhesive, heat fusion, and ultrasonic welding.

12. The closed annular seal according to claim 10, wherein the end portions of the band-shaped bodies are joined by heat fusion or ultrasonic welding with at least one component selected from a tetrafluoroethylene-hexafluoro propylene copolymer film and a tetrafluoroethylene-perfluoroalkyl vinyl ether copolymer film

13. The closed annular seal according to claim 1 obtained by bending the band-shaped bodies into a circle and temporarily fixing and heat setting the bodies to maintain the circular configuration, wherein the two ends of the band-shaped bodies are joined either before, after, or simultaneously with the heat setting.

14. The closed annular seal according to claim 2 obtained by bending the band-shaped bodies into a circle and temporarily fixing and heat setting the bodies to maintain the circular configuration, wherein the two ends of the band-shaped bodies are joined either before, after, or simultaneously with the heat setting.

15. The closed annular seal according to claim 4 obtained by bending the band-shaped bodies into a circle and temporarily fixing and heat setting the bodies to maintain the circular configuration, wherein the two ends of the band-shaped bodies are joined either before, after, or simultaneously with the heat setting.
